(19) United States
(12) Patent Application Publication
(10) Pub. No.: US 2026/0183165 A1
(43) Pub. Date: Jul. 2, 2026

(54) PRESSURE VESSEL AND CONTROL THEREOF FOR A SUPPORT SURFACE

(71) Applicant: Stryker Corporation, Portage, MI (US)

(72) Inventors: Matthew T. Thielking, Schoolcraft, MI (US); Michael W. Graves, Paw Paw, MI (US); Jerald A. Trepanier, Augusta, MI (US)

(21) Appl. No.: 19/411,882

(22) Filed: Dec. 8, 2025

Related U.S. Application Data
(60) Provisional application No. 63/739,788, filed on Dec. 30, 2024.

(51) Int. Cl. A61G 7/057; A61G 7/018

(52) U.S. Cl. CPC A61G 7/05769; A61G 7/018

(57) ABSTRACT

A patient support system that utilizes more than one air source in the process of inflating an inflatable bladder associated with a patient support. At least one of the air sources includes a pressure vessel or reservoir capable of storing compressed fluid, such as air.

### TECHNICAL FIELD

The present disclosure relates to mattresses used for supporting individuals thereon, and more particularly to mattresses that are used in healthcare settings and that have one or more inflatable zones and a pressure vessel.

### BACKGROUND

In healthcare settings, mattresses are used to support patients positioned on beds, stretchers, cots, and the like. In many instances, such mattresses include one or more inflatable bladders whose inflation levels can be controlled. In order to reduce the likelihood of the patient developing bed sores, or aggravating pre-existing bed sores, the inflation level of the bladders should be set so as to distribute the patient's weight over as great an area as possible, or over an area large enough to reduce undesired force concentrations on the patient's body. Additionally, one or more of the inflatable bladders may be configured to assist in turning a patient toward a left side or a right side.

Conventional mattresses having inflatable bladders often include a compressor capable of pressurizing an inflatable bladder with fluid. These compressors, however, take up a significant portion of space, are noisy, and often take too long to fill the inflatable bladder.

### SUMMARY OF THE DESCRIPTION

In general, one innovative aspect of the subject matter described herein can be embodied in a patient support system for a patient support apparatus including a deck with one or more deck sections. The patient support system may include an inflatable bladder and a patient support that is supported on the deck. The patient support system may include a first fluid source operable to supply fluid under pressure, and a pressure vessel operable as a second fluid source to supply fluid under pressure. The pressure vessel may be operable to receive and store fluid under pressure from the first fluid source. The patient support system may include a selectable valve coupled to both the first fluid source and the pressure vessel as the second fluid source. The patient support system may include a control system configured to direct inflation of the inflatable bladder and operable to deflate the inflatable bladder. The control system may be operable to control the selectable valve to direct inflation of the bladder via fluid under pressure from at least one of the first and second fluid sources.

The foregoing and other aspects can each optionally include one or more of the following features, alone or in combination. In particular, one aspect includes all the following features in combination.

In some aspects, the selectable valve may be operable to selectively direct fluid under pressure from the air mover as the first fluid source to the pressure vessel.

In some aspects, the selectable valve may be operable to selectively direct fluid under pressure from the air mover as the first fluid source to the inflatable bladder.

In some aspects, the patient support system may include a second selectable valve operable to selectively control supply of fluid under pressure from the pressure vessel as the second fluid source to the inflatable bladder. The control system may be operably coupled to the second selectable valve to selectively control supply of fluid under pressure from the pressure vessel as the second fluid source to the inflatable bladder, so that the control system may be operable to selectively supply fluid under pressure to the inflatable bladder from one or both of the first and second fluid sources.

In some aspects, the air mover may be a compressor.

In some aspects, a check valve may be provided between the air mover and the pressure vessel to prevent reverse flow of fluid from the pressure vessel to the air mover.

In some aspects, the inflatable bladder may correspond to a turn bladder operable to assist in turning the patient.

In some aspects, the patient support system may include a second inflatable bladder, where the control system may be configured to direct inflation and deflation of the second inflatable bladder, and where the control system may be operable to direct inflation of the second inflatable bladder via fluid under pressure from at least one of the first and second fluid sources.

In some aspects, the patient support system may include a sensor system operable to generate sensor output indicative of a fluid pressure of the pressure vessel.

In some aspects, the patient support system may include a venturi valve operably coupled to the inflatable bladder, the venturi valve fluidly coupled between the inflatable bladder and a deflation port for the inflatable bladder. The control system may be operable to direct deflation of the inflatable bladder via the deflation port, where the control system may be operable to direct supply of fluid from the second fluid source to the venturi valve to facilitate deflation of the inflatable bladder.

In general, one innovative aspect of the subject matter described herein can be embodied in a patient support system for a patient support apparatus that includes a deck with one or more deck sections. The patient support system may include a patient support supported on the deck and including an inflatable bladder. The patient support system may include a pressure vessel operable as a first fluid source to supply fluid under pressure, and operable to receive and store fluid under pressure. The patient support system may include a first air mover operable to supply fluid under pressure to the pressure vessel for storage by the pressure vessel, and a second air mover operable as a second fluid source to supply fluid under pressure.

The patient support system may include a control system configured to direct inflation of the inflatable bladder and operable to deflate the inflatable bladder. The control system may be operable to direct inflation of the bladder via fluid under pressure from at least one of the first and second fluid sources.

The foregoing and other aspects can each optionally include one or more of the following features, alone or in combination. In particular, one aspect includes all the following features in combination.

In some aspects, the selectable valve may be operable to selectively direct fluid under pressure from the first air mover to the pressure vessel.

In some aspects, the selectable valve may be operable to selectively direct fluid under pressure from the pressure vessel as the first fluid source to the inflatable bladder.

In some aspects, the control system may be operable to control supply of fluid under pressure from the second air mover as the second fluid source to the inflatable bladder, so that the control system may be operable to supply fluid under pressure to the inflatable bladder from both the first and second fluid sources.

In some aspects, the first air mover may be a compressor, and where the second air mover may be a blower.

In some aspects, a check valve may be provided between the first air mover and the pressure vessel to prevent reverse flow of fluid from the pressure vessel to the first air mover.

In some aspects, the inflatable bladder may correspond to a turn bladder operable to assist in turning the patient.

In some aspects, the control system may be configured to direct inflation and deflation of the second inflatable bladder, where the control system may be operable to direct inflation of the second inflatable bladder via fluid under pressure from at least one of the first and second fluid sources.

In some aspects, the patient support system may include a sensor system operable to generate sensor output indicative of a fluid pressure of the pressure vessel.

In some aspects, the patient support system may include a venturi valve operably coupled to the inflatable bladder. The venturi valve may be fluidly coupled between the inflatable bladder and a deflation port for the inflatable bladder, where the control system may be operable to direct deflation of the inflatable bladder via the deflation port, and where the control system may be operable to direct supply of fluid from the pressure vessel to the venturi valve to facilitate deflation of the inflatable bladder.

In general, one innovative aspect of the subject matter described herein can be embodied in a patient support system for a patient support apparatus including a deck with one or more deck sections. The patient support system may include a patient support supported on the deck and including an inflatable bladder. The inflatable bladder may be associated with a support surface region of the patient support. The patient support system may include an air mover operable as a first fluid source to supply fluid under pressure, and a pressure vessel operable as a second fluid source to supply fluid under pressure. The pressure vessel may be operable to receive and store fluid under pressure from the air mover. The patient support system may include a venturi valve operably coupled to the inflatable bladder. The venturi valve may be fluidly coupled between the inflatable bladder and a deflation port for the inflatable bladder.

The patient support system may include a control system configured to direct inflation of the inflatable bladder. The control system may be operable to direct inflation of the bladder via fluid under pressure from at least one of the first and second fluid sources. The control system may be operable to direct deflation of the inflatable bladder via the deflation port, and operable to direct supply of fluid from the second fluid source to the venturi valve to facilitate deflation of the inflatable bladder.

The foregoing and other aspects can each optionally include one or more of the following features, alone or in combination. In particular, one aspect includes all the following features in combination.

In some aspects, the patient support system may include a selectable valve operable to selectively direct fluid under pressure from the air mover as the first fluid source to the pressure vessel.

In some aspects, the selectable valve may be operable to selectively direct fluid under pressure from the air mover as the first fluid source to the inflatable bladder.

In some aspects, the patient support system may include a second selectable valve operable to selectively control supply of fluid under pressure from the pressure vessel as the second fluid source to the inflatable bladder, where the control system may be operably coupled to the second selectable valve to selectively control supply of fluid under pressure from the pressure vessel as the second fluid source to the inflatable bladder, so that the control system may be operable to selectively supply fluid under pressure to the inflatable bladder from one or both of the first and second fluid sources.

In some aspects, the air mover may be a compressor.

In some aspects, a check valve may be provided between the air mover and the pressure vessel to prevent reverse flow of fluid from the pressure vessel to the air mover.

In some aspects, the inflatable bladder may correspond to a turn bladder operable to assist in turning the patient.

In some aspects, the patient support system may include a second inflatable bladder. The control system may be configured to direct inflation and deflation of the second inflatable bladder, where the control system may be operable to direct inflation of the second inflatable bladder via fluid under pressure from at least one of the first and second fluid sources.

In some aspects, the patient support system may include a sensor system operable to generate sensor output indicative of a fluid pressure of the pressure vessel.

In some aspects, the patient support system may include a selectable valve operably coupled between the venturi valve and the pressure vessel, where the control system may be configured to direct the selectable valve to direct fluid under pressure from the pressure vessel to the venturi valve.

Before the embodiments and aspects of the disclosure are explained in detail, it is to be understood that the disclosure is not limited to the details of operation or to the details of construction and the arrangement of the components set forth in the following description or illustrated in the drawings. The disclosure may be implemented in various other embodiments and aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments and aspects. Unless otherwise expressly stated, the use of enumeration should not be construed as limiting one or more embodiments or aspects to any specific order or number of components. Nor should the use of enumeration be construed as excluding from the scope of an embodiment or aspect any additional steps or components that might be combined with or into the enumerated steps or components.

### BRIEF DESCRIPTION OF THE DRAWINGS

FIG. 1 shows a patient support apparatus according to one aspect of the present disclosure.

FIG. 2 shows a patient support according to one aspect of the present disclosure.

FIG. 3 shows a perspective view of a patient support according to one aspect of the present disclosure.

FIG. 4 shows a partial, exploded view of the patient support of FIG. 3.

FIG. 5 depicts a control system for a patient support according to one aspect of the present disclosure.

FIG. 6 shows a fluid control system for a patient support according to one aspect.

FIG. 7 shows another fluid control system for a patient support according to one aspect.

FIG. 8 shows yet another fluid control system for a patient support according to one aspect.

FIG. 9 shows further another fluid control system for a patient support according to one aspect.

FIG. 10 shows yet still another fluid control system for a patient support according to one aspect.

FIG. 11 shows further still another fluid control system for a patient support according to one aspect.

FIG. 12 shows a representative top view of the patient support according to one aspect.

FIG. 13 shows a representative side view of another patient support according to one aspect.

### DESCRIPTION

A patient support system is provided and is capable of utilizing more than one air source in the process of inflating an inflatable bladder associated with a patient support. At least one of the air sources includes a pressure vessel or reservoir capable of storing compressed fluid, such as air.

In one aspect, a patient support system may include a compressor for supplying fluid to an inflatable bladder. In many cases, packaging the compressor within an integrated pump box (e.g., a pump box or pump assembly inside the mattress) is limited by many constraints and affects the ability to arrive at a construction that is operable while maintaining patient comfort. A pressure vessel may be utilized in conjunction with the compressor so that a smaller compressor (e.g., a low flow but high-pressure capability compressor) can be used to pressurize the pressure vessel. The pressure vessel size and pressure capabilities may vary depending on the volume of the mattress air bladders and the target pressure. In one aspect, the pressure vessel may be used to fill an inflatable bladder of the mattress bladders. The pressure vessel can be located inside the footbox (e.g., the pump assembly) or external to the mattress. The pressure vessel may alternatively be a large, high pressure “fill bladder” within the mattress. The pressure vessel may enable use of a smaller compressor, which helps maintain areas of foam, gel, or air bladders for patient comfort. The pressure vessel or fill bladder can then be packaged and positioned appropriately to also maintain patient comfort requirements.

One benefit of the pressure vessel is that, once the system is pressurized (e.g., a mattress air bladder, pod, or turn bladder), adjustments in pressure can be conducted with substantially no sound or vibration. In other words, fluid from the pressure vessel may be supplied and/or fluid can be exhausted from an inflatable bladder without activating a compressor or other mechanically noisy or vibrating component. This is particularly beneficial if a patient is asleep.

Filling the mattress pods or turn bladders can also be done slowly or quickly from the pressure vessel or fill bladder (controlled via a proportional valve). In other words, the pressure vessel may enable faster filling relative to a stand-alone compressor, decreasing the time required to achieve target therapy settings. Depending on the size and/or pressure of the pressure vessel or fill bladder, multiple therapies could be performed before needing to re-pressurize the system via the compressor.

Boyle's law of P1*V1=P2 *V2 is the main equation that may be used to determine system requirements. The equation may be modified so that the left side corresponds to the number of Joules of potential energy associated with the pressure vessel, and the right side of the equation corresponds to the number of Joules of potential energy associated with a target inflatable bladder times the target number of turns the inflatable bladder can be filled by the pressure vessel without re-pressurizing the pressure vessel. For instance, a pressure vessel with a volume of 48 cubic inches and a pressure of 4500 PSI can be used to fill an inflatable bladder with a volume of 3374 cubic inches to 1.7 PSI about 37 times.

The patient support 20 according to one or more aspects described herein may utilize a pressure vessel in conjunction with one or more additional fluid movers. This configuration may enable one or more of the following: 1) a customizable package size (e.g., a smaller compressor and pressure vessel); 2) simplified fill speed regulation; 3) faster fill times for inflatable bladders (e.g., turn bladders); 4) potential multiple pod or turn bladder fills (without running a compressor) before needing to re-pressurize the system (e.g., the system may perform mattress adjustments silently while the patient is sleeping); and 5) little to no vibration when performing pod or bladder fills (e.g., sound/vibration may be limited to when the pressure vessel needs to be re-pressurized).

### I. Overview

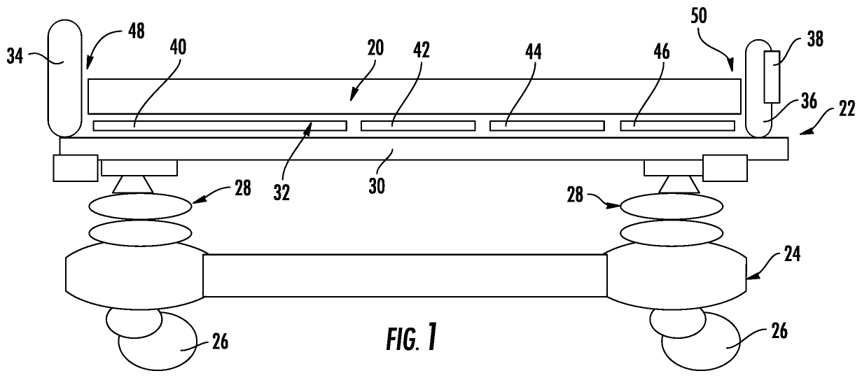

FIG. 1 illustrates a patient support 20 according to one aspect of the present disclosure. In the example of FIG. 1, the patient support 20 is a mattress. However, it will be understood that the patient support 20 may take on other manifestations, such as cushions, pads, etc. Indeed, in one aspect, the patient support 20 may be a cushion or pad for a chair, such as a wheelchair or a stationary chair. In general, the patient support 20 may be utilized wherever and whenever a patient is to be supported on a surface and it is desirable to reduce interface pressures experienced by the patient while positioned on the patient support 20.

In FIG. 1, the patient support 20 is supported on a patient support apparatus 22 that, in this particular configuration, is a bed. The patient support apparatus 22 may take on other forms besides beds, such as, but not limited to cots, stretchers, operating tables, gurneys, and the like. The patient support apparatus 22 may be a conventional support apparatus that is commercially available and that merely provides a supporting function for the patient support 20. In other aspects, the patient support apparatus 22 may include one or more controls that are integrated therein, and which are used in controlling the operation of the patient support 20, as will be discussed in greater detail herein.

As shown in FIG. 1, the patient support apparatus 22 includes a base 24 having a plurality of wheels 26, a pair of elevation adjustment mechanisms 28 supported on the base 24, a frame or litter 30 supported on the elevation adjustment mechanisms 28, and a patient support deck 32 supported on the frame 30. The patient support apparatus 22 may also include a headboard 34 and a footboard 36. Either, or both, of the headboard 34 and the footboard 36 may be removable from the frame 30 and may include one or more electrical connectors for establishing electrical communication between electronic components on or in the footboard 36 and/or the headboard 34 and other electronic components supported on or in the frame 30. Such electrical connector(s) may include any one or more of the connectors disclosed in commonly assigned U.S. patent application Ser. No. 13/790,762, filed Mar. 8, 2013, by applicant Krishna Bhimavarapu and entitled PATIENT SUPPORT APPARATUS CONNECTORS, the disclosure of which is incorporated herein by reference in its entirety. Other types of connectors may also be used.

In one aspect, electrical connectors may be provided for establishing an electrical link between the patient support 20 and a user interface 38 that is positioned on, or integrated into, the footboard 36 or another aspect of the patient support apparatus 22. The user interface 38 may take on a variety of different forms, such as, but not limited to, a touch screen, a Liquid Crystal Display (LCD), a plurality of buttons, switches, knobs, or the like, or any combination of these components. The user interface 38 may allow a user to control the operation of the patient support 20. The electrical connection between the user interface 38 and the patient support 20 may take on different forms, including a direct electrical cable that runs from the footboard 36 to the patient support 20. As another example, the footboard 36 may include electrical connectors that electrically couple the user interface 38 to circuitry supported on the frame 30. This circuitry may be in further electrical communication with a port (not shown) to which an electrical cable from the patient support 20 may be inserted, thereby establishing an electrical link between the user interface 38 and the patient support 20. In yet another example, communication between the user interface 38 and the patient support 20 may be entirely wireless. A further example of such wireless communication is disclosed in commonly assigned U.S. patent application Ser. No. 13/802,992, filed Mar. 24, 2013, by applicants Michael Hayes et al. and entitled COMMUNICATION SYSTEMS FOR PATIENT SUPPORT APPARATUSES, the complete disclosure of which is hereby incorporated herein by reference.

The elevation adjustment mechanisms 28 are adapted to raise and lower the frame 30 with respect to the base 24. The elevation adjustment mechanisms 28 may be implemented as hydraulic actuators, electric actuators, or any other suitable device for raising and lowering the frame 30 with respect to the base 24. In FIG. 1, the elevation adjustment mechanisms 28 are depicted to be operable independently so that the orientation of the frame 30 with respect to the base 24 may also be adjusted. This may allow the patient support apparatus 22 to tilt a patient supported on the patient support 20 to either the Trendelenburg orientation, or the reverse Trendelenburg orientation.

The frame 30 may provide a structure for supporting the patient support deck 32, the headboard 34, and the footboard 36. The patient support deck 32 may provide a surface on which the patient support 20 can be positioned so that a patient may lie and/or sit thereon. The patient support deck 32 may be made of a plurality of sections, some of which may be pivotable about generally horizontal pivot axes—although it is to be understood that the patient support deck 32 may be configured differently without a plurality of sections (e.g., one section). In the configuration shown in FIG. 1, the patient support deck 32 includes a head or back section 40, a seat section 42, a thigh section 44, and a foot section 46. In other configurations, the patient support deck 32 may include fewer or greater numbers of sections. The head section 40, which is also sometimes referred to as a Fowler section or back section, may be pivotable between a generally horizontal orientation (shown in FIG. 1) and a plurality of raised positions (not shown in FIG. 1). The thigh section 44 and the foot section 46 may also be pivotable about horizontal pivot axes.

The general construction of any of the base 24, the elevation adjustment mechanisms 28, the frame 30, the patient support deck 32, the headboard 34, and/or the footboard 36 may take on any known or conventional design, such as, for example, that disclosed in commonly assigned, U.S. Pat. No. 7,690,059 issued to Lemire et al., and entitled HOSPITAL BED, the complete disclosure of which is incorporated herein by reference; or that disclosed in commonly assigned U.S. Pat. Publication No. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosure of which is also hereby incorporated herein by reference. The construction of any of the base 24, the elevation adjustment mechanisms 28, the frame 30, the patient support deck 32, the headboard 34, and/or the footboard 36 may also take on forms different from what is disclosed in the aforementioned patent and patent publication.

In some aspects, the operation of the patient support 20 may be based at least partially upon sensor data that originates from sensors integrated into the patient support apparatus 22, while in other aspects, the patient support 20 may operate solely on sensor data originating from sensors positioned internally inside of the patient support 20. For those aspects in which the patient support 20 uses sensor data from the patient support apparatus 22, such sensor data may include angle data and/or weight data. More specifically, the patient support apparatus 22, in some aspects, may include one or more angle sensors that detect the angular orientation (with respect to horizontal) of the frame 30, as well as one or more angle sensors that detect the angular orientation (with respect to horizontal) of one or more of the sections of the support deck 32. Still further, the patient support apparatus 22, in some aspects, may include a load cell system that detects patient weight and/or a center of gravity of a patient positioned on the patient support 20. One such load cell system that may be used in patient support apparatus 22 is disclosed in commonly assigned U.S. Pat. No. 5,276,432 issued to Travis, and entitled PATIENT EXIT DETECTION MECHANISM FOR HOSPITAL BED, the complete disclosure of which is incorporated herein by reference. Other load cell systems may also be used. Regardless of the specific load cell system used, the patient support apparatus 22 may communicate any one or more of patient weight, patient center of gravity, the angular orientation of the frame 30, and/or the angular orientation of one or more of the deck sections 40, 42, 44, 46 to the patient support 20, which may use this data in manners discussed in further detail herein.

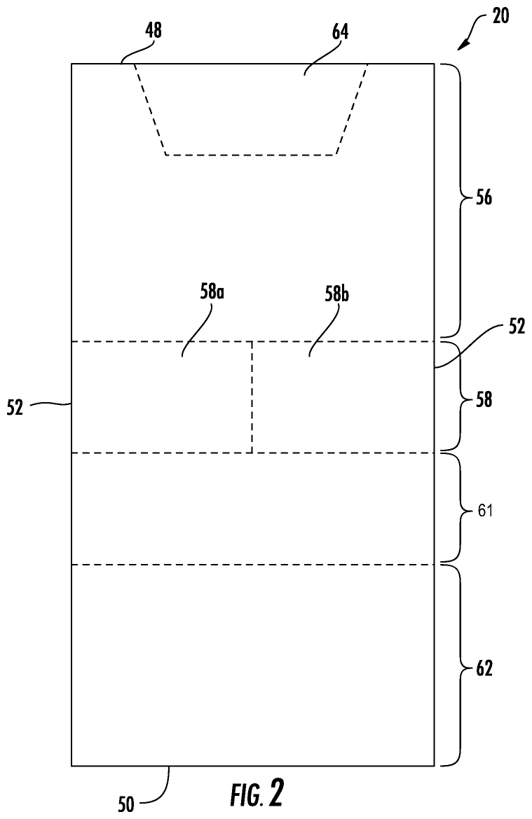

Turning to FIG. 2, the patient support 20 may further include a back zone 56, a thigh zone 61, and a foot zone 62. The back zone 56 may include a head zone or pillow zone 64. The physical boundaries of each of the zones may be modified from that shown, as well as the number of locations of each zone. In the configuration of FIG. 2, the back zone 56 is positioned such that it will generally be aligned with the head or back section 40 of the patient support apparatus 22 when the patient support 20 is positioned on the support deck 32. Similarly, the seat zone 58 will be generally aligned with the seat section 42, the thigh zone 61 will be generally aligned with the thigh section 44, and the foot zone 62 will be generally aligned with the foot section 46. Such alignment, however, is not necessary. Indeed, the patient support 20 may be used on patient support apparatuses 22 in which the support deck 32 has no individual sections, or which has a fewer or greater number than the four shown in FIG. 1.

The seat zone 58, as depicted shown in FIG. 2, is subdivided into right and left sides. That is, the seat zone 58 includes a right seat zone 58a and a left seat zone 58b. Each of the seat zones 58a and 58b define regions in which hermetically isolated bladders (also described as pods herein) may be positioned so that the inflation level corresponding to the right seat zone 58a can be controlled and/or set independently of the inflation level corresponding to the left seat zone 58b. In this manner, if a patient is lying on his or her side or is otherwise positioned closer to one side 52 than the other, zones 58a and 58b can be set, at least in some configurations, to different inflation levels. Alternatively, the inflation levels may be set for zones 58a and 58b differently in situations where the patient is positioned more toward the middle of the patient support 20. In alternative configurations, the seat zone 58 may be a single zone that does not have separate subdivisions between the right and left side, but rather is inflatable and deflatable in a unitary manner. In still other alternative configurations, one or more of the other zones 56, 60, and/or 62 may be subdivided into left and right sub-zones, or sub-divided in still other manners.

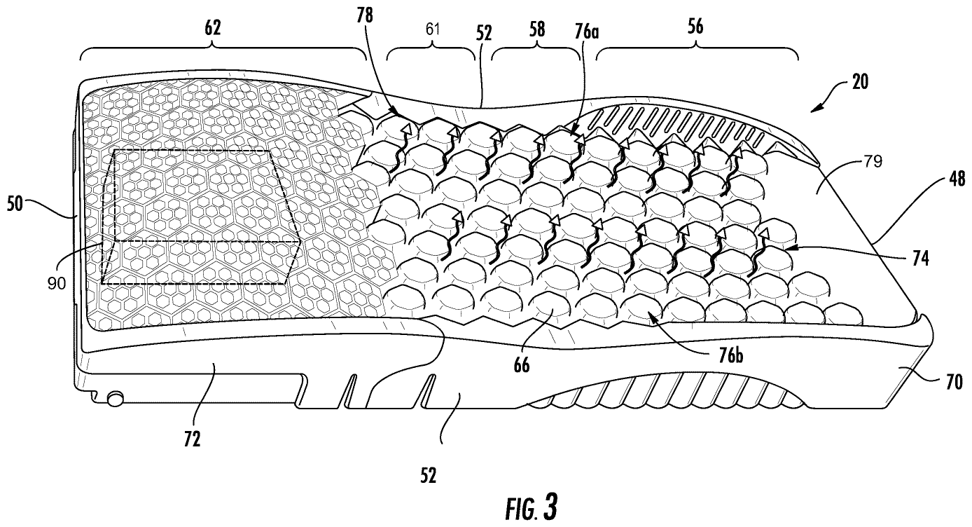

FIG. 3 shows the patient support 20 with its outer cover removed, exposing a plurality of inflatable pods 66, as well as a pillow bladder 79, a foam crib 70 that supports the pods 66, and molded foot end cushioning 72. Foam cushioning 72 is not inflatable but instead provides cushioned support to a patient's feet through its soft pliability. In an alternative configuration, the foam crib 70 may be absent entirely or in one or more areas of the periphery of the patient support 20. In this configuration, in place of the foam crib 70, one or more inflatable pods 66 may be provided. As an example, the one or more inflatable pods 66 may be provided at the periphery in areas where the foam crib 70 is provided in the configuration depicted in FIG. 3.

In one configuration, the inflatable pods 66 are fluidly coupled together in a manner that forms an inflatable zone. For instance, all of the inflatable pods 66 within the back zone 56 may inflate and deflate together and can be inflated and deflated separately from the inflatable pods 66 in any of the other zones. Similarly, all of the inflatable pods 66 in the right seat zone 58a, all of the inflatable pods 66 in the left seat zone 58b, as well as all of the inflatable pods 66 in the thigh zone 61, are respectively able to be inflated and deflated together, as well as separately from the inflatable pods 66 in the other zones. Thus, the inflatable pods 66 in the back zone 56 collectively define a back bladder 74, the inflatable pods 66 in the right seat zone 58a collectively define a right seat bladder 76a, the inflatable pods 66 in the left seat zone 58b collectively define a left seat bladder 76b, and the inflatable pods 66 in the thigh zone 61 collectively define a thigh zone bladder 78. It is to be understood that the bladders 74, 76a, 76b, and/or 78 can be implemented, in alternative configurations, in manners other than pods, such as, but not limited to, elongated bladders, flat bladders, can-shaped bladders, or still other shapes.

In FIG. 4, various components of the patient support 20 are shown in the back zone 56 and the seat zone 58 of FIG. 3. The patient support 20 includes a top cover 96, a fire barrier layer 97, a layer of conductive fabric 98, the inflatable pods 66, a fabric manifold 102, a foam crib 70, a plurality of turning bladders 104, six depth sensors 94, and a bottom cover 106. The top cover 96 may be made of any conventional material used in the manufacture of hospital mattresses, such as, but not limited to, a knit polyester, and/or a polyurethane. The top cover 96 in FIG. 4 is the uppermost layer of the patient support 20—although it is to be understood that the uppermost layer may be different depending on the configuration of the patient support 20. Likewise, the fire barrier layer 97 and the conductive fabric 98 may form intermediate layers between the uppermost layer and the inflatable pods 66. An additional example of an intermediate layer is a low air loss layer that is operable to receive and distribute air for microclimate control. One or more or all of the intermediate layers may be absent in alternative configurations.

The fire barrier 97 may be positioned underneath the top cover 96 (or an uppermost layer) and may be made of any suitable material that resists the spread of fire. Such materials may vary. In one configuration, the fire barrier 97 may be made of, or include, Kevlar® (poly-paraphenylene terephthalamide), or other brands of para-aramid synthetic fibers. Other materials may alternatively be used.

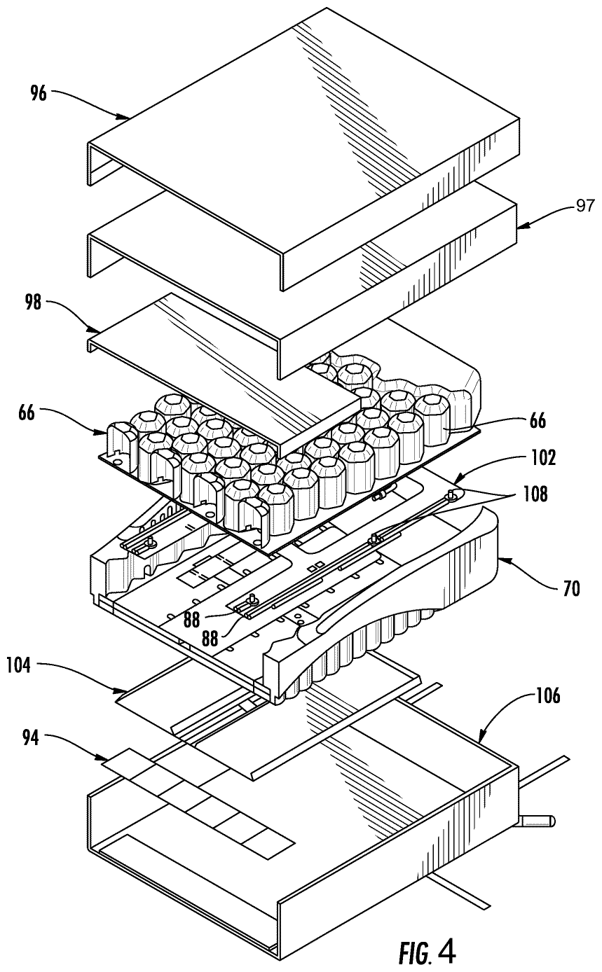

The conductive fabric 98 may operate to assist depth sensors 94 which, in the configuration shown, are capacitive sensors whose output changes as a patient moves closer or farther away from them. More specifically, the conductive fabric 98 may function in a manner similar to the top plate of a parallel plate capacitor, while the depth sensors 94 form the bottom plates of the parallel plate capacitor. Thus, as the vertical distance between the conductive fabric 98 and any of the depth sensors 94 changes, the capacitance between the fabric 98 and the depth sensors 94 will change. This change may be detected by a detector circuit 112 (FIG. 5) that is electrically coupled between the conductive fabric 98 and each of the depth sensors 94. That is, one or more wires (not shown) are electrically coupled to the conductive fabric 98 and the detector circuits 112, while one or more other wires (not shown) are connected between each depth sensor 94 and the detector circuit 112. The conductive fabric 98 may be any commercially available fabric that is electrically conductive, or it may be an electrically conductive foil, or any other material that is electrically conductive, and that is flexible enough to not significantly alter the flexibility of the patient support 20 in that region. Examples of the depth sensors 94 and circuitry associated therewith are described in further detail in U.S. Pat. No. 11,413,202 to Lefleche et al., issued Aug. 8, 2022, assigned to Stryker Corp.—the disclosure of which is hereby incorporated by reference in its entirety. It is to be understood that depth sensors 94 may be configured differently depending on the application and may be absent in some configurations.

In one configuration, the top cover 96, or an intermediate layer, or a combination thereof, may include one or more sensors, such as interface sensors (depicted in FIG. 5) operable to detect an interface pressure between the patient and the patient support 20. Additionally, or alternatively, one or more sensors may be provided above the top cover 96. The interface sensors may provide sensor feedback to the pump assembly 90, which may use the sensor feedback as a basis for controlling an inflation state of the inflatable pods 66, or groups thereof.

The inflatable pods 66, as described herein, may be inflated and deflated in groups (e.g., zones 56, 58a, 58b, and 60) under the control of a pump assembly 90 depicted in FIG. 1 and its associated control circuitry. The fluid connections between the inflatable pods 66 and the pump assembly 90 may be established by a plurality of hoses 88 that run between the pump assembly 90 and various of the inflatable pods 66. The hoses 88 are housed within the fabric manifold 102. The hoses 88 each include one or more connectors 108 for fluidly connecting the hose to one or more of the inflatable pods 66.

The pump assembly 90 may be provided within an enclosure provided proximal to the foot end 50 of the patient support 20. The pump assembly 90 may be provided beneath the foot zone 62 within an enclosure. It is to be understood that the pump assembly 90 may be configured and positioned differently depending on the application.

The pump assembly 90, as described herein, may include more than one air mover, such as an air pump, blower, pressure vessel, and another source of fluid (e.g., air) that may be supplied to the hoses 88 for delivery to the inflatable pods 66 and/or the turn bladders 104. Additionally, the pump assembly 90 may be operable to remove fluid from the turn bladders 104 and/or the inflatable pods 66 via the hoses 88. In this way, with the capability to supply and remove fluid, the pump assembly 90 may selectively inflate and deflate the inflatable pods 66 in groups. In an alternative configuration, the pump assembly 90 may selectively inflate and deflate one or more of the turn bladders 104 and the inflatable pods 66, individually. As described herein, the pump assembly 90 may be operable to determine an inflation state of the turn bladders 104 and the inflatable pods 66 and/or groups thereof, and to direct a change in the inflation state based on at least one of sensor data and a directive from a caregiver provided via the user interface 38.

The turn bladders 104 may be positioned underneath the foam crib 70 and may be used to help turn a patient positioned on top of the patient support 20. To that end, the turn bladders 104 may extend generally longitudinally in a direction from the head end 48 to the foot end 50 and are each separately and independently inflatable and deflatable. The inflation of the turn bladders 104 may be controlled by the pump assembly 90 and its associated circuitry, as described herein.

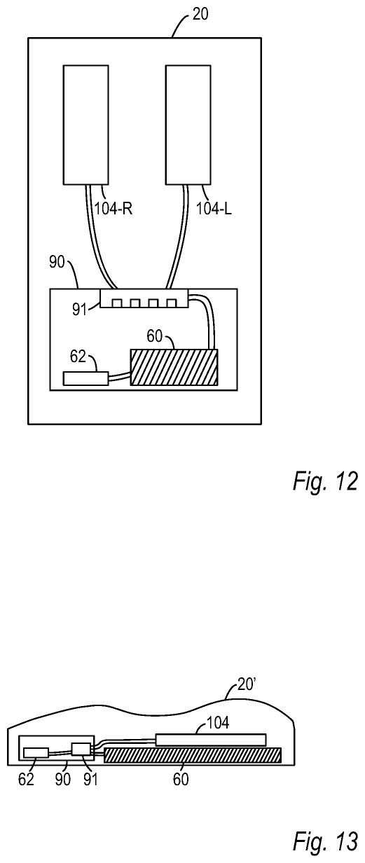

FIGS. 12 and 13 show various implementations of the patient support 20 including turn bladders 104 in conjunction with a pump assembly 90 disposed near a foot end of the patient support 20. The turn bladders 104 as described herein may be disposed on left and right sides of the patient support 20 and are labeled L and R accordingly. The pump assembly 90 may include a manifold assembly 91 capable of selectively directing fluid to one or more inflatable bladders of the patient support 20, such as the turn bladders 104. The manifold assembly 91 may be directed by the fluid control driver of the main control board 128 so that inflation of the one or more bladders can be directed according to a selected mode of operation for the patient support 20.

As described herein, and as depicted in FIG. 12, the patient support 20 may include a first air mover in the form of a compressor 62 and a second air mover in the form of a pressure vessel 60. The compressor 62 may be directed to supply fluid to the pressure vessel 60 by a fluid control system, such as a fluid control system described according to one or more aspects herein. The location of the pressure vessel 60 may vary from application to application—e.g., the pressure vessel 60 is disposed in the pump assembly 90 in FIG. 12. As another example, in FIG. 13, a patient support 20′ is shown in a configuration similar to the patient support 20 in FIG. 12, except the pressure vessel 60 is disposed outside the pump assembly 90 and beneath the turn bladders 104 of the patient support 20. It is to be understood that the pressure vessel 60 may be disposed anywhere with respect to the patient support 20 and/or the patient support apparatus 22, including external to one or both of the patient support 20 and the patient support apparatus 22.

### II. Control System

FIG. 5 shows one configuration of a control system 114 that may be implemented to control the patient support 20 in the manner described herein. Other types, arrangements, and/or configurations of control systems may alternatively be used. The control system 114 may include a control system 116, a user interface 118, and a plurality of sensor systems, such as one or more of the depth sensor systems 120, a tilt sensor 124, a moisture sensor with respect to the patient support surface for detecting moisture proximal to the patient, a temperature sensor for detecting temperature proximal to the patient, an air pressure sensor 122, and an interface pressure sensor 125. It is to be understood that one or more of these aspects may be absent from implementations of the control system 114, such that the control system 114 may include a subset of the described aspects.

The user interface 118 may be the same as user interface 38, discussed above, which is incorporated into the footboard 36 of the patient support apparatus 22, or it may be a stand-alone user interface. Such stand-alone user interfaces may include user interfaces that are incorporated into pedestals that may be removably mounted on patient beds, such as the patient support apparatus 22. In the configuration shown in FIG. 5, the user interface 118 is a touch screen. It is to be understood that other types of user interfaces may be used, including buttons, switches, knobs, lights, and/or displays.

Each depth sensor system 120 includes one of the depth sensors 94, a corresponding detector 112, the conductive fabric 98, and, in some configurations, a shield (not shown) positioned underneath the depth sensor 94. The detector 112 may be any circuitry capable of detecting the varying capacitance between the depth sensor 94 and the conductive fabric 98. In one configuration, the detector 112 may include an AD7747 capacitance-to-digital converter manufactured by Analog Devices of Norwood, Mass. Other types of detector circuitry may be used in other aspects. Whatever the circuitry used, the detectors 112 may detect the capacitance levels between depth sensor 94 and the conductive fabric 98, which provide an indication of the vertical distance between the depth sensor 94 and the conductive fabric 98, which in turn indicates how deeply a patient is currently immersed in different areas of the seat zone 58. The number and type of the depth sensor systems 120 may vary depending on the application. In FIG. 5, there are six separate detector circuits 112, thereby generating six separate measurements of patient depth in the seat zone 58. In one configuration, depth sensor systems 120 each generate capacitive measurements multiple times a second, while in other configurations, measurements are made at different frequencies. As mentioned herein, the depth sensor system 120 may be absent or configured differently depending on the configuration.

The main control system 116 may be in electrical communication with both the user interface 118 and the depth sensor systems 120, as well as a plurality of air pressure sensors 122 and, in FIG. 5, one or more tilt sensors 124. The main control system 116 in one configuration may be coupled to one or more interface pressure sensors 125, which as discussed herein may be operable to detect an interface pressure between the patient and the patient support 20. Additional sensors, such as a temperature sensor or a moisture sensor, or both may be coupled to the main control system 116. Additionally, or alternatively, one or more sensors described herein may be absent from the main control system 116.

The air pressure sensors 122 may measure the current air pressure inside one or more of the turn bladders 104 and the inflatable bladders 66 of the patient support 20 (e.g., back bladder 74, seat bladders 76a and 76b, thigh bladder 78, and pillow bladder 79). Each of these inflatable bladders 66 generally corresponds to zones 56, 58a, 58b, 60, and 64, respectively.

Tilt sensors 124 measure the angular orientation of one or more portions of the patient support 20, and/or they measure the entire angular orientation of the patient support 20. In some aspects as was discussed previously, tilt sensors 124 are omitted and the patient support 20 instead receives tilt data from one or more angle sensors that are incorporated into the patient support apparatus 22. In still other aspects, the patient support 20 is implemented without any tilt sensors 124, and without receiving any tilt data from the patient support apparatus 22.

The main control system 116 in FIG. 5 includes two separate circuit boards: a sensor circuit board 126 and a main control circuit board 128. The sensor circuit board 126 may receive the electrical signals from all of the various sensors and oversees the operation of these sensors (e.g., depth sensors 120, air pressure sensors 122, tilt sensors 124, interface pressure sensors 125, a temperature sensor, and a moisture sensor). The data gathered from one or more of these various sensors may be forwarded from the sensor circuit board 126 to the main control circuit board 128, and may be used as a basis for controlling supply of fluid to an inflatable bladder of the patient support 20, such as one or more of the turn bladders 104 and the inflatable bladders 66.

In one configuration, this data from one or more sensors may be communicated via a serial peripheral interface (SPI) bus, although it is to be understood that other buses may be used for this purpose. The main circuit board 128 may be programmed, or otherwise configured, to carry out the control algorithms described herein. Generally speaking, the main circuit board 128 may determine suitable inflation levels (e.g., a desired air pressure or—for those bladders with depth sensors 120—a desired patient depth) for all of the various bladders and controls, valves, air movers, and other aspects to implement and maintain those suitable inflation levels.

As shown in FIG. 5, each board 126 and 128 includes a processor, which may be a microprocessor or a microcontroller. Indeed, each circuit board 126 and 128 may include any electrical component, or group of electrical components, that are capable of carrying out the algorithms described herein. In many configurations, the circuit boards 126 and 128 may be microprocessor-based, although not all such configurations may utilize a microprocessor. In general, the circuit boards 126 and 128 may include any one or more microprocessors, microcontrollers, field programmable gate arrays, systems on a chip, volatile or nonvolatile memory, discrete circuitry, and/or other hardware, software, or firmware that is capable of carrying out the functions described herein. Such components may be physically configured in any suitable manner, such as by mounting them to one or more circuit boards, or arranging them in other manners, whether combined into a single unit or distributed across multiple units. It is to be further understood that the main control system 116 may be implemented in different forms from the two boards 126 and 128 illustrated in FIG. 5. Such variations may include combining the functions of both boards 126 and 128 onto a single board, or further distributing the functions of these boards onto more than the two boards 126 and 128 shown in FIG. 5.

### III. Fluid Control System and Air Movers

In FIG. 5, the control system 114 includes a fluid control system 130 (e.g., an air control system) operably coupled to the main circuit board 128. The main circuit board 128 may include a fluid control driver configured to direct operation of the fluid control system 130 based on directives from a pressure vessel control system implemented by the main control board 128—although control over the fluid control system 130 may be implemented differently. For instance, the fluid control system 130, itself, may include a control system operable to control aspects of the fluid control system 130 independently of the main circuit board 128 and/or based on directives from the main circuit board 128 or another component of the patient support 20.

In one aspect, by way of electrical signals sent to the fluid control system 130, the main control board 128 may be able to implement suitable inflation levels of the various bladders. The fluid control system 130 may be operable to exhaust air from one or more of the turn bladders 104 and the inflatable bladders 66, or groups thereof, to the atmosphere and/or to an air mover of the air control system 130.

The fluid control system 130 may be operably coupled to one or more fluid movers 60, 62, 64 to control supply to and/or from the one or more fluid movers 60, 62, 64. For instance, the fluid control system 130 may direct one fluid mover to another fluid mover and/or to an inflatable bladder of the patient support 20.

One or more aspects of the fluid control system 130 and/or the one or more fluid movers 60, 62, 64 may be incorporated into the pump assembly 90. For instance, as described, the fluid control system 130 may include a plurality of fluid valves operably coupled to one or more air movers 60, 62, 64—these components or a subset thereof may be provided in the pump assembly 90 proximal to the foot end 50 of the patient support 20. Optionally, one or more components of the fluid control system 130 and the one or more air movers 60, 62, 64 may be external to the pump assembly 90, and further optionally one or more of such components may be external to the patient support 20.

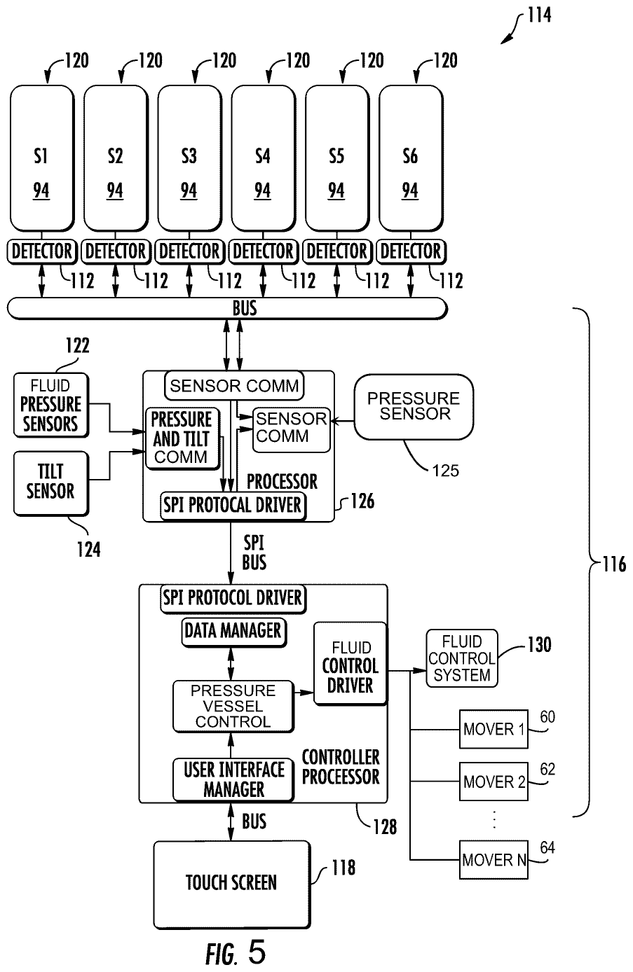

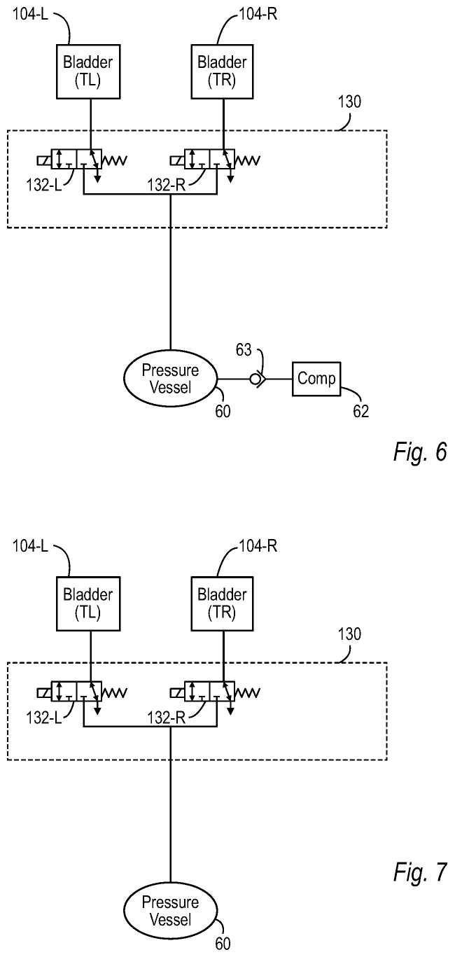

A fluid control system 130 according to one aspect is shown in FIG. 6 and includes a first valve 132-L and a second valve 132-R associated respectively with left and right turn bladders 104-L, 104-R. The first and second valves 132-L, 132-R may selectively direct fluid from the pressure vessel 60 respectively to the left and right turn bladders 104-L, 104-R. It is to be understood that the number and type of valves may vary from application to application and that the present disclosure is not limited to supplying fluid to turn bladders 104. For instance, for purposes of disclosure, several aspects are described herein in conjunction with supplying fluid to turn bladders 104; however, any inflatable bladder may be used in place of the turn bladders 104 described in conjunction with these aspects, such that fluid may be supplied to any inflatable bladder according to one or more aspects described herein.

The pressure vessel 60 may be a fluid reservoir or tank capable of storing fluid received by another air mover, such as a compressor 62. The pressure vessel 60, itself, may be considered an air mover by virtue of being capable of supplying fluid to another component, such as an inflatable bladder, with fluid stored in the pressure vessel 60. The pressure vessel 60, in one aspect, may operate as a buffer between the compressor 62 and a turn bladder 104-L, 104-R.

The pressure vessel 60 may facilitate supply of fluid to an inflatable bladder of the patient support 20 in a variety of ways.

For instance, the pressure vessel 60 may store fluid provided by another air mover, such as the compressor 62, so that the load on the other air mover may be reduced during periods of greater demand. The compressor 62 may re-supply the pressure vessel 60 with fluid during periods of lesser demand. This arrangement may allow for a compressor 62 with a lower maximum flow capacity because the pressure vessel 60 may be available for supplying fluid when there is greater demand. This arrangement may also allow for flow stabilization because the pressure vessel 60 may provide a more stable fluid source relative to the compressor 62, which may be turned on and off intermittently in order to satisfy the fluid flow demands of the inflatable bladder. Ultimately, this mode of operation may further reduce overall deterioration of the compressor 62 over time. An additional effect of using the pressure vessel 60 in addition to the compressor 62 includes cooling of the fluid by virtue of flowing through the pressure vessel 60.

The size or capacity of the pressure vessel 60 may vary from application to application. In one aspect, the capacity of the pressure vessel 60 may be sufficient so that the compressor 62 can be selected for one or more constraints, such as size, cost, target lifespan, the maximum output pressure, and maximum flow capacity, or a combination thereof.

The structure of the pressure vessel 60 may vary from application to application. As an example, in some configurations, the pressure vessel 60 may be a fixed, rigid enclosure, and in other configurations, the pressure vessel 60 may be a flexible enclosure capable of expanding and contracting in volume based on the pressure therein.

In FIG. 6, the compressor 62 may correspond to a first air mover, and the pressure vessel 60 may correspond to a second air mover. The compressor 62 may supply fluid, such as air, to the pressure vessel 60, and a check valve 63 may be disposed along the fluid path from the compressor 62 to the pressure vessel 60 in order to prevent back flow of fluid from the pressure vessel 60 to the compressor 62.

The main control board 128 may direct one or both of the valves 132-L, 132-R to selectively open and provide a fluid path from the pressure vessel 60 to one or both of the turn bladders 104-L, 104-R so that the pressure vessel 60 is operable to supply fluid as an air mover to one or both of the turn bladders 104-L, 104-R. The compressor 62 may supply fluid to the pressure vessel 60 while the pressure vessel 60 is supplying fluid to one or both of the turn bladders 104-L, 104-R and/or while the valves 132-L, 132-R are closed so that the pressure vessel 60 is fluidly disconnected from the turn bladders 104-L, 104-R.

The valves 132-L, 132-R of the fluid control system 130 may vary from application to application. In FIG. 6, the valves 132-L, 132-R correspond to pneumatic valves in a 3/2 configuration with an integrated exhaust port. It is to be understood that the valve configuration and type may be different.

In operation, the main control board 128 may direct the compressor 62 to supply fluid to the pressure vessel 60. Supply of fluid from the compressor 62 to the pressure vessel 60 may be provided according to one or more criteria, such as for a predetermined period of time or until a sensor (not shown) detects the pressure of the pressure vessel 60 being at or above a threshold pressure value. The main control board 128 may also direct the control system 130 to supply fluid from the pressure vessel 60 to one or both of the turn bladders 104-L, 104-R, as described herein.

An alternative aspect is shown in FIG. 7 with the pressure vessel 60 being the sole depicted air mover. A second air mover (not shown) may be configured to supply fluid to the pressure vessel 60, similar to the compressor 62 in FIG. 6. The second air mover in one aspect may correspond to an external supply of fluid, such as a hospital air source, that can be removably coupled to the fluid control system 130 and/or to the aspects of the patient support 20 and/or the patient support apparatus 22, such as to the pressure vessel 60. Optionally, the pressure vessel 60 may be external to the patient support 20 and/or the patient support apparatus 22 and may be filled by another air source that is external as well.

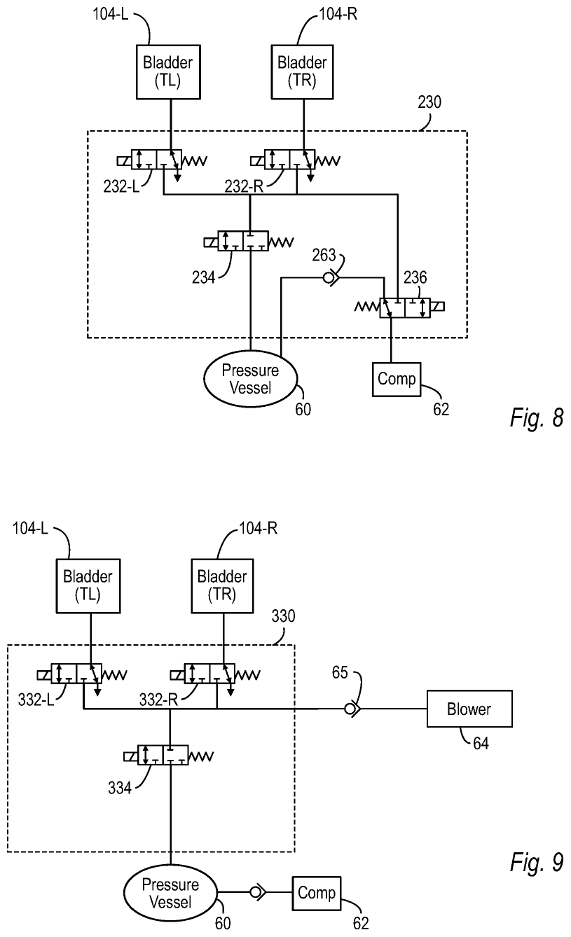

Turning to FIG. 8, yet another aspect is shown with a fluid control system 230, similar to the fluid control system 130, in that the fluid control system 230 is directed by the fluid control driver of the main control board 128. The fluid control system 230, similar to the fluid control system 130, may be configured to selectively supply fluid to an inflatable bladder of the patient support 20, such as one or both of the turn bladders 104-L, 104-R.

The fluid control system 230 in FIG. 8 is configured to interface with first and second air movers in the form of a compressor 62 and a pressure vessel 60. Generally speaking, the fluid control system 230 may be operable to supply fluid from one or both of the pressure vessel 60 and the compressor 62 to a turn bladder 104-L, 104-R. The fluid control system 230 may include several valves configured to enable such operation. For instance, the fluid control system 230 may include first and second valves 232-L, 232-R respectively, coupled to the turn bladders 104-L, 104-R, and capable of selectively enabling fluid flow to the turn bladders 104-L, 104-R similar to the first and second valves 132-L, 132-R.

The fluid control system 230 includes a pressure vessel control valve 234 and a compressor control valve 236. The pressure vessel control valve 234 may be operatively controlled by the main control board 128 to selectively provide fluid from the pressure vessel 60 the first and second valves 232-L, 232-R, which may direct the fluid to one of the turn bladders 104-L, 104-R.

The compressor control valve 236 may be configured to selectively provide fluid to one of the pressure vessel 60 or the first and second valves 232-L, 232-R, which as mentioned, may direct the fluid to one of the turn bladders 104-L, 104-R. The fluid control system 230 may be directed to supply fluid to one of the turn bladders 104-L, 104-R in at least three ways: 1) the pressure vessel control valve 232 may be active to supply fluid from the pressure vessel 60 to a turn bladder 104-L, 104-R via selective activation of one of the 1st and 2nd valves 232-L, 232-R; 2) the compressor control valve 236 may be active to supply fluid directly from the compressor 62 to a turn bladder 104-L, 104-R via selective activation of one of the first and second valves 232-L, 232-R; and 3) both the pressure vessel control valve 232 and the compressor control valve 236 may be active to supply fluid respectively from the pressure vessel 60 and the compressor 62 to a turn bladder 104-L, 104-R and be a selective activation of one of the first and second valves 232-L, 232-R. The pressure vessel 60 and the compressor 62 may provide fluid to the turn bladder 104-L, 104-R for the same duration, or for first and second periods of time that may or may not overlap with each other.

Additionally, or alternatively, the compressor control valve 236 may be activated to supply fluid from the compressor 62 to the pressure vessel 60 in order to resupply the pressure vessel 60 with fluid for storage. In FIG. 8, a check valve 263 may be provided between the compressor control valve 236 and the pressure vessel 60 in order to prevent backflow or reverse flow of fluid from the pressure vessel 60 to the compressor control valve 236 and the compressor 62.

In FIG. 9, yet another aspect is shown with a fluid control system 330 similar to the fluid control system 130 in that the fluid control system 330 is directed by the fluid control driver of the main control board 128. The fluid control system 330, similar to the fluid control system 130, may be configured to selectively supply fluid to an inflatable bladder of the patient support 20, such as one or both of the turn bladders 104-L, 104-R.

The fluid control system 330 in FIG. 9 is configured to utilize three air movers for controlling supply of fluid to an inflatable bladder of the patient support 20. For instance, the fluid control system 330 in FIG. 9 is configured to interface with first, second, and third air movers in the form of a compressor 62, a pressure vessel 60, and a blower 64. Generally speaking, the fluid control system 330 may be operable to supply fluid from one or both of the blower 64 and the pressure vessel 60 to a turn bladder 104-L, 104-R. The fluid control system 330 may include several valves configured to enable such operation. For instance, the fluid control system 330 may include first and second valves 332-L, 332-R respectively, coupled to the turn bladders 104-L, 104-R and capable of selectively enabling fluid flow to the turn bladders 104-L, 104-R similar to the first and second valves 132-L, 132-R.

The fluid control system 330 includes a pressure vessel control valve 334 that may be operatively controlled by the main control board 128 to selectively provide fluid from the pressure vessel 60 to the first and second valves 332-L, 332-R, which may direct the fluid to one of the turn bladders 104-L, 104-R.

The compressor 62 may be fluidly coupled to the pressure vessel 60 in a manner similar to the configuration depicted and described in conjunction with FIG. 6. For instance, the compressor 62 may be activated to supply fluid via a check valve 63 to the pressure vessel 60 in order to store fluid within the pressure vessel 60 and supply such fluid on demand from the pressure vessel 60 to an inflatable bladder of the patient support 20. The compressor 62 may be controlled to supply fluid to the pressure vessel 60 in a variety of ways and according to a variety of criteria, such as being able to control the supply of fluid for a duration of time or based on sensor feedback indicative of a pressure of the fluid within the pressure vessel 60.

In FIG. 9, the blower 64 may be fluidly coupled to the first and second valves 332-L, 332-R and configured to supply fluid to a turn bladder 104-L, 104-R. A check valve 65 may be provided in the fluid path between the blower 64 and the first and second valves 332-L, 332-R to prevent back flow of fluid to the blower 64. The blower 64 may be selectively activated via a directive from the main control board 128 to supply fluid to an inflatable bladder. In operation, the blower 64 is unlikely to be sized or configured to supply fluid at a pressure corresponding to target pressure of the inflatable bladder—however, the blower 64 may be operable to supply a high flow of fluid at a lower pressure than the target pressure.

The blower 64 may be utilized in a multiple stage inflation operation, with the blower 64 being utilized to supply fluid initially to the inflatable bladder and the pressure vessel 60 being fluidly coupled to the inflatable bladder via the pressure vessel control valve 334 in order to complete or take over inflation of the inflatable bladder when the blower 64 is no longer providing fluid flow at a rate or pressure sufficient to complete inflation of the bladder (potentially, within a target period of time).

The pressure vessel control valve 334 may be directed (e.g., by the main control board 128 or another component) to activate for supply of fluid to a turn bladder 104 according to one or more criteria depending on the application. For instance, the pressure vessel control valve 334 may activate to provide fluid from the pressure vessel 60 to a turn bladder 104-L, 104-R, via a respective first or second valve 332-L, 332-R, after a period of time for which the blower 64 has been active to supply fluid to the turn bladder 104-L, 104-R. Additionally, or alternatively, the pressure vessel control valve 334 may be activated at the same time as the blower 64 for simultaneous supply of fluid to the turn bladder 104-L, 104-R. Yet further additionally or alternatively, the pressure vessel control valve 334 may be activated based on a sensed pressure with respect to the turn bladder 104-L, 104-R, such as in response to detecting the pressure exceeding a threshold. The threshold may be determined based on performance aspects of the blower 64, such as a flow rate or inflation curve for the blower 64 relative to the turn bladder 104-L, 104-R, so that the pressure vessel control valve 334 can be activated after a sensed threshold pressure for which it is determined the blower 64 provides a lower flow rate than the pressure vessel 60 for a given pressure.

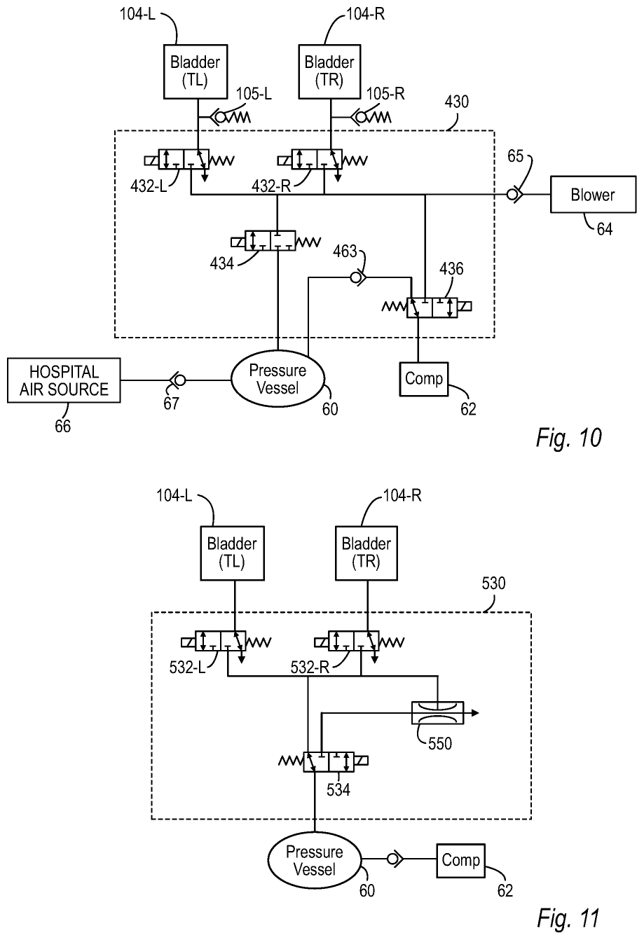

In FIG. 10, yet a further aspect is shown with a fluid control system 430 similar to the fluid control system 330 in that the fluid control system 430 is directed by the fluid control driver of the main control board 128. The fluid control system 430, similar to the fluid control system 330, may be configured to selectively supply fluid to an inflatable bladder of the patient support 20, such as one or both of the turn bladders 104-L, 104-R. The turn bladders 104-L, 104-R in FIG. 10 are shown in conjunction with pressure relief valves 105-L, 105-R configured to dissipate pressure in the fluid lines and the turn bladders 104-L, 104-R if the pressure exceeds a threshold value. The pressure relief valves are shown in FIG. 10—however, it is to be understood that the pressure relief valves may be absent or present in any of the other aspects described herein in conjunction with the turn bladders 104-L, 104-R.

The fluid control system 430 in FIG. 10 is configured to utilize three air movers for controlling supply of fluid to an inflatable bladder of the patient support 20. For instance, the fluid control system 430 in FIG. 10 is configured to interface with first, second, and third air movers in the form of a compressor 62, a pressure vessel 60, and a blower 64. Generally speaking, the fluid control system 430 may be operable to supply fluid from one or more of the blower 64, the compressor 62, and the pressure vessel 60 to a turn bladder 104-L, 104-R. The fluid control system 430 may include several valves configured to enable such operation. For instance, the fluid control system 430 may include first and second valves 432-L, 432-R respectively coupled to the turn bladders 104-L, 104-R and capable of selectively enabling fluid flow to the turn bladders 104-L, 104-R similar to the first and second valves 132-L, 132-R.

In FIG. 10, the fluid control system 430 includes a pressure vessel control valve 434 and a compressor control valve 436, which may be configured to operate in a manner similar to the pressure vessel control valve 234 and a compressor control valve 236 of the fluid control system 230. For instance, the compressor control valve 436 may be configured to selectively provide fluid to one of the pressure vessel 60 or the first and second valves 432-L, 432-R, which, as mentioned, may direct the fluid to one of the turn bladders 104-L, 104-R. Additionally, similar to the fluid control system 330, the blower 64 may be active to supply to a turn bladder 104-L, 104-R in conjunction with one or both of the pressure vessel 60 and the compressor 62.

In this way, the fluid control system 430 may be directed to supply fluid to one of the turn bladders 104-L, 104-R in at several ways, including any combination of the following:
1) the pressure vessel control valve 434 may be active to supply fluid directly from the pressure vessel 60 to a turn bladder 104-L, 104-R via selective activation of one of the first and second valves 432-L, 432-R; 2) the compressor control valve 436 may be active to supply fluid directly from the compressor 62 to a turn bladder 104-L, 104-R via selective activation of one of the first and second valves 432-L, 432-R; 3) the blower 64 may be activated to supply fluid directly to a turn bladder 104-L, 104-R via selective activation of one of the first and second valves 432-L, 432-R. For instance, in one combination, both the pressure vessel control valve 434 and the compressor control valve 436 may be active to supply fluid respectively from the pressure vessel 60 and the compressor 62 to a turn bladder 104-L, 104-R and be a selective activation of one of the first and second valves 432-L, 432-R. In another example combination, the pressure vessel control valve 434 and the compressor control valve 436 may be active in conjunction with the blower 64 in order to supply fluid to a turn bladder via all three of the air movers. The potential combinations of air movers to supply fluid to a turn bladder need not be operable to supply such fluid during the same periods of time. For instance, a first air mover may be operable to supply fluid for a first period of time, and a second air mover may be operable to supply fluid for a second period of time, where both the first and second periods of time may or may not be overlapping. A third air mover may also be operable to supply fluid for a third period of time, which may or may not overlap with one or both of the first and second periods of time.

In FIG. 10, a check valve 463 may be provided between the compressor control valve 436 and the pressure vessel 60 in order to prevent backflow or reverse flow of fluid from the pressure vessel 60 to the compressor control valve 436 and the compressor 62.

The blower 64 may be operated in conjunction with the flow control system 430 in a manner similar to that described in conjunction with the flow control system 330. For instance, in one aspect, the blower 64 may be utilized in a multiple stage inflation operation, with the blower 64 being utilized to supply fluid initially to the inflatable bladder and the pressure vessel 60 and/or the compressor 62 being fluidly coupled to the inflatable bladder via at least one of the pressure vessel control valve 434 in order to complete or take over inflation of the inflatable bladder when the blower 64 is no longer providing fluid flow at a rate or pressure sufficient to complete inflation of the bladder (potentially, within a target period of time). One or both of the pressure vessel control valve 434 and the compressor control valve 436 may be activated for a supply of fluid respectively from the compressor 62 and the pressure vessel 60.

The pressure vessel control valve 436 may be selectively controlled to supply fluid from the compressor 62 to the pressure vessel 60, enabling supply of fluid for storage in the pressure vessel 60. This mode of operation may be similar to the mode of operation for the pressure vessel control valve 236 described in conjunction with FIG. 8.

In one aspect, shown in dashed lines in FIG. 10, an external air source may also be coupled to the system as a fourth air mover. For instance, a hospital air source 66 may be removably coupled to a component of the patient support 20 and/or the patient support apparatus 22 to supply fluid selectively to a turn bladder 104-L, 104-R (or another type of inflatable bladder as discussed herein). In FIG. 10, the hospital air source 66 is fluidly coupled to the pressure vessel 60 via a check valve 67, which may prevent back flow of fluid from the pressure vessel 60 to the hospital air source 66. In cases where the pressure of fluid in the pressure vessel 60 is below the pressure output from the hospital air source 66, fluid may flow from the hospital air source 66 to the pressure vessel 60 thereby resupplying the pressure vessel 60 with fluid that can be directed selectively to a turn bladder 104-L, 104-R.

Turning to the configuration depicted in FIG. 11, an assisted deflation aspect is provided. A fluid control system 530 is provided that is similar in many respects to the fluid control system 130 but there are several exceptions. For instance, the fluid control system 530, similar to the fluid control system 130, may be configured to selectively supply fluid to an inflatable bladder of the patient support 20, such as one of the turn bladders 104-L, 104-R. The pressure vessel 60 may be operable to receive fluid from the compressor 62 for storage and supply of such fluid to the turn bladder 104-L, 104-R.

In FIG. 11, the fluid control system 530 includes a pressure vessel control valve 534 operable in ways that are similar but also different from the pressure vessel control valve 234. For instance, like the pressure vessel control valve 234, the pressure vessel control valve 534 may be operable to selectively supply fluid from the pressure vessel 60 to a turn bladder 104-L, 104-R via the first or second control valves 532-L, 532-R. However, the pressure vessel control valve 534 may also be operable to selectively supply fluid from the pressure vessel 60 to a venturi-based exhaust valve 550, which may be configured to facilitate exhausting fluid from a turn bladder 104-L, 104-R.

In operation, the fluid control system 530 may be directed to selectively provide fluid from the pressure vessel 60 to the venturi-based exhaust valve 550. In this configuration, one or both of the turn bladders 104-L, 104-R may be fluidly coupled to the venturi based exhaust valve 550 via the 1st and 2nd control valves 532-L, 532-R. Flow of fluid through the venturi based exhaust valve 550 from the pressure vessel 60 may increase a flow rate of exhausted fluid from the turn bladder 104-L, 104-R by generating a vacuum relative to the fluid flow path to the turn bladder 104-L, 104-R, enabling faster exhausting or deflation of fluid therefrom.

Directional terms, such as “vertical,” “horizontal,” “top,” “bottom,” “upper,” “lower,” “inner,” “inwardly,” “outer” and “outwardly,” are used to assist in describing embodiments and aspects of the present disclosure based on the orientation of the embodiments and aspects shown in the illustrations. The use of directional terms should not be interpreted to limit embodiments or aspects to any specific orientation(s).

The above description is that of current embodiments and aspects of the disclosure. Various alterations and changes can be made without departing from the spirit and broader aspects of the disclosure as defined in the appended claims, which are to be interpreted in accordance with the principles of patent law including the doctrine of equivalents. This disclosure is presented for illustrative purposes and should not be interpreted as an exhaustive description of all embodiments or aspects of the disclosure or to limit the scope of the claims to the specific elements illustrated or described in connection with these embodiments or aspects. For example, and without limitation, any individual element(s) of the described embodiments or aspects may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments and aspects include a plurality of features that are described in concert and that might cooperatively provide a collection of benefits. The present disclosure is not limited to only those embodiments or aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

While several forms have been shown and described, other changes and modifications will be appreciated by those skilled in the relevant art. Therefore, it will be understood that the embodiments shown in the drawings and described above are merely for illustrative purposes, and are not intended to limit the scope of the disclosure which is defined by the claims which follow as interpreted under the principles of patent law including the doctrine of equivalents.

1. A patient support system for a patient support apparatus including a deck with one or more deck sections, the patient support system comprising:
a patient support supported on the deck and including an inflatable bladder;
a first fluid source operable to supply fluid under pressure;
a pressure vessel operable as a second fluid source to supply fluid under pressure, the pressure vessel operable to receive and store fluid under pressure from the first fluid source;
a selectable valve coupled to both the first fluid source and the pressure vessel as the second fluid source; and
a control system configured to direct inflation of the inflatable bladder, the control system operable to deflate the inflatable bladder, the control system operable to control the selectable valve to direct inflation of the inflatable bladder via fluid under pressure from at least one of the first and second fluid sources.

2. The patient support system of claim 1, wherein the selectable valve is operable to selectively direct fluid under pressure from an air mover as the first fluid source to the pressure vessel, and wherein the selectable valve is operable to selectively direct fluid under pressure from the air mover as the first fluid source to the inflatable bladder, and comprising a second selectable valve operable to selectively control supply of fluid under pressure from the pressure vessel as the second fluid source to the inflatable bladder, wherein the control system is operably coupled to the second selectable valve to selectively control supply of fluid under pressure from the pressure vessel as the second fluid source to the inflatable bladder, such that the control system is operable to selectively supply fluid under pressure to the inflatable bladder from one or both of the first and second fluid sources.

3. The patient support system of claim 1, wherein the first fluid source is external to the patient support.

4. The patient support system of claim 1, wherein the first fluid source is a compressor.

5. The patient support system of claim 1, wherein a check valve is provided between the first fluid source and the pressure vessel to prevent reverse flow of fluid from the pressure vessel to the first fluid source.

6. The patient support system of claim 1, wherein the inflatable bladder corresponds to a turn bladder operable to assist in turning a patient.

7. The patient support system of claim 1, comprising a second inflatable bladder, wherein the control system is configured to direct inflation and deflation of the second inflatable bladder, and wherein the control system is operable to direct inflation of the second inflatable bladder via fluid under pressure from at least one of the first and second fluid sources.

8. The patient support system of claim 1, comprising a sensor system operable to generate sensor output indicative of a fluid pressure of the pressure vessel.

9. The patient support system of claim 1, comprising a venturi valve operably coupled to the inflatable bladder, the venturi valve fluidly coupled between the inflatable bladder and a deflation port for the inflatable bladder, wherein the control system is operable to direct deflation of the inflatable bladder via the deflation port, and wherein the control system is operable to direct supply of fluid from the second fluid source to the venturi valve to facilitate deflation of the inflatable bladder.

10. A patient support system for a patient support apparatus including a deck with one or more deck sections, the patient support system comprising:
a patient support supported on the deck and including an inflatable bladder;
a pressure vessel operable as a first fluid source to supply fluid under pressure, the pressure vessel operable to receive and store fluid under pressure;
a first air mover operable to supply fluid under pressure to the pressure vessel for storage by the pressure vessel;
a second air mover operable as a second fluid source to supply fluid under pressure; and
a control system configured to direct inflation of the inflatable bladder, the control system operable to deflate the inflatable bladder, the control system operable to direct inflation of the inflatable bladder via fluid under pressure from at least one of the first and second fluid sources.

11. The patient support system of claim 10, wherein a selectable valve is operable to selectively direct fluid under pressure from the first air mover to the pressure vessel, wherein the selectable valve is operable to selectively direct fluid under pressure from the pressure vessel as the first fluid source to the inflatable bladder, and wherein the control system is operable to control supply of fluid under pressure from the second air mover as the second fluid source to the inflatable bladder, so that the control system is operable to supply fluid under pressure to the inflatable bladder from both the first and second fluid sources.

12. The patient support system of claim 11, wherein the first air mover is a compressor, and wherein the second air mover is a blower.

13. The patient support system of claim 10, comprising a second inflatable bladder, wherein the control system is configured to direct inflation and deflation of the second inflatable bladder, wherein the control system is operable to direct inflation of the second inflatable bladder via fluid under pressure from at least one of the first and second fluid sources.

14. The patient support system of claim 10, comprising a venturi valve operably coupled to the inflatable bladder, the venturi valve fluidly coupled between the inflatable bladder and a deflation port for the inflatable bladder, wherein the control system is operable to direct deflation of the inflatable bladder via the deflation port, and wherein the control system is operable to direct supply of fluid from the pressure vessel to the venturi valve to facilitate deflation of the inflatable bladder.

15. A patient support system for a patient support apparatus including a deck with one or more deck sections, the patient support system comprising:
a patient support supported on the deck and including an inflatable bladder, the inflatable bladder being associated with a support surface region of the patient support;
an air mover operable as a first fluid source to supply fluid under pressure;
a pressure vessel operable as a second fluid source to supply fluid under pressure, the pressure vessel operable to receive and store fluid under pressure from the air mover;
a venturi valve operably coupled to the inflatable bladder, the venturi valve fluidly coupled between the inflatable bladder and a deflation port for the inflatable bladder; and
a control system configured to direct inflation of the inflatable bladder, the control system operable to direct inflation of the inflatable bladder via fluid under pressure from at least one of the first and second fluid sources, the control system operable to direct deflation of the inflatable bladder via the deflation port, the control system operable to direct supply of fluid from the second fluid source to the venturi valve to facilitate deflation of the inflatable bladder.

16. The patient support system of claim 15, comprising a selectable valve operable to selectively direct fluid under pressure from the air mover as the first fluid source to the pressure vessel.

17. The patient support system of claim 16, wherein the selectable valve is operable to selectively direct fluid under pressure from the air mover as the first fluid source to the inflatable bladder, and comprising a second selectable valve operable to selectively control supply of fluid under pressure from the pressure vessel as the second fluid source to the inflatable bladder, wherein the control system is operably coupled to the second selectable valve to selectively control supply of fluid under pressure from the pressure vessel as the second fluid source to the inflatable bladder, so that the control system is operable to selectively supply fluid under pressure to the inflatable bladder from one or both of the first and second fluid sources.

18. The patient support system of claim 15, wherein the air mover is a compressor.

19. The patient support system of claim 15, comprising a second inflatable bladder, wherein the control system is configured to direct inflation and deflation of the second inflatable bladder, wherein the control system is operable to direct inflation of the second inflatable bladder via fluid under pressure from at least one of the first and second fluid sources.

20. The patient support system of claim 15, comprising a selectable valve operably coupled between the venturi valve and the pressure vessel, and wherein the control system is configured to direct the selectable valve to direct fluid under pressure from the pressure vessel to the venturi valve.
